(19) United States
(12) Patent Application Publication
(10) Pub. No.: US 2026/0336084 A1
(43) Pub. Date: Oct. 29, 2026

(54) MACHINE TOOL HAVING A PROTECTIVE ELEMENT

(71) Applicant: Hilti Aktiengesellschaft, Schaan (LI)

(72) Inventors: Thomas BADER, Landsberg am Lech (DE); Karin GROTH, Herrsching (DE); Timo SEEL, Wiedergeltingen (DE); Manuel ROSENZWEIG, Kaufering (DE); Juan ZHU, Kaufering (DE); Torsten TUSSING, Obermeitingen (DE); Mark DULING, Hiltenfingen (DE)

(21) Appl. No.: 18/995,666

(22) PCT Filed: Jul. 25, 2023
(86) PCT No.: PCT/EP2023/070564

§ 371 Date: Jan. 16, 2025

(30) Foreign Application Priority Data
Aug. 8, 2022 (EP) 22189233.4

(51) Int. Cl. B25D 17/04

(52) U.S. Cl. CPC B25D 17/043; B25D 2217/0073; B25D 2250/095; B25D 2250/121; B25D 2250/245

(57) ABSTRACT

A machine tool, in particular a jack hammer, has a housing, a working axis running in a longitudinal direction, at least one rechargeable battery interface device for detachably connecting at least one rechargeable battery to the machine tool, and a first side handle having a first main extension direction and a second side handle having a second main extension direction. The side handles are arranged substantially symmetrically to the working axis. At least one decoupling device is provided for a vibration-damping connection of the side handles to the housing. At least one rechargeable battery interface device is coupled to a side handle. At least one protective device is provided for protecting a rechargeable battery coupled to the rechargeable battery interface device. The at least one protective device has an interior for at least partially receiving the at least one rechargeable battery. At least one protective device is connected directly to the housing or is an integral component of the housing.

The present invention relates to a machine tool, in particular a jack hammer.

### BACKGROUND

A percussion hammer with a housing is known from DE 10 2018 210 189 A1, wherein a center of gravity of the machine tool is arranged substantially on the working axis. The machine tool has a rechargeable battery interface via which a rechargeable battery pack can be detachably connected to the machine tool. The handles are each connected to the housing via a damping unit. It is further disclosed that the rechargeable battery pack is arranged below a handle and protected by a protective element connected to the handle.

### SUMMARY OF THE INVENTION

Disadvantageously, protection of the rechargeable battery pack in such an embodiment can be insufficient or undesirably low in particular in the event of the machine tool falling or in the event of impacts.

It is an object of the present invention to provide a machine tool, in particular a jack hammer, in which protection of rechargeable batteries connected to the machine tool is improved.

A machine tool, in particular a jack hammer, is provided with a housing, a working axis running in a longitudinal direction, at least one rechargeable battery interface device for detachably connecting at least one rechargeable battery to the machine tool, and a first side handle and a second side handle, wherein the side handles are arranged substantially symmetrically to the working axis, wherein at least one decoupling device is provided for a vibration-damping connection of the side handles to the housing, wherein at least one rechargeable battery interface device is coupled to a side handle, wherein at least one protective device is provided for protecting a rechargeable battery coupled to the rechargeable battery interface device, and wherein the at least one protective device has an interior for at least partially receiving the at least one rechargeable battery.

According to the invention, the protective device is connected directly to the housing or is an integral component of the housing.

A machine tool designed according to the invention has the advantage that at least one rechargeable battery connected to the at least one rechargeable battery interface device is protected to the desired extent against damage in a simple manner in particular in all operating states of the machine tool. This is achieved by arranging the protective device fixed to the housing which allows the protective device to be designed particularly stable and robust, and transfers forces acting thereon directly to the housing of the machine tool. In the embodiment according to the invention, the protective device is arranged on the housing independently of the decoupling device. In the solution according to the invention, the protective device is therefore not subject to the damping properties of the decoupling device, whereby improved protection of a rechargeable battery connected to the rechargeable battery interface device is achievable.

Furthermore, the decoupling device is also particularly well protected by arranging the at least one protective device fixed to the housing since the at least one decoupling device is at least not directly exposed to impacts, shocks or the like, for example from the machine tool falling or dropping, because of the indirect connection to the protective device.

Furthermore, by the at least one rechargeable battery interface being connected to a side handle during operation of the machine tool, a decoupling of a rechargeable battery connected to the rechargeable battery interface device from the housing is provided so that vibrations and shocks occurring during operation of the machine tool act on the rechargeable battery interface device, and hence also on a rechargeable battery connected to the rechargeable battery interface device, in particular only to a greatly reduced extent.

A connection of the protective device to the housing can be configured to be both non-detachable and detachable.

The first side handle and the second side handle each define a first main extension direction and a second main extension direction, wherein the main extension directions when the side handles are in an unloaded state are arranged in particular substantially perpendicular to the longitudinal direction and extend substantially in a transverse direction. A center of gravity of the machine tool in an upright position preferably lies substantially on the working axis.

Due to the arrangement of the rechargeable battery interface device on the first and/or second side handle, an installation height of the machine tool in the longitudinal direction is advantageously low. In addition, when the rechargeable battery is arranged on the rechargeable battery interface device, a user's view of the machine tool is advantageously not obstructed by the rechargeable battery. Furthermore, compared to an arrangement of the rechargeable battery interface device in an end region of the machine tool facing away from a tool holder, a center of gravity of the machine tool is advantageously arranged close to a machining surface. As a result, a maximum fall height of a rechargeable battery connected to the rechargeable battery interface device during operation of the machine tool is also reduced in relation to an arrangement of the rechargeable battery in an end region of the machine tool facing away from the tool holder, so that the risk of damage to a rechargeable battery connected to the rechargeable battery interface device is reduced.

The decoupling device reduces mechanical effects such as impacts, shocks or the like acting on a user who is holding the machine tool by the side handles during operation of the machine tool. Furthermore, a rechargeable battery connected to the rechargeable battery interface device is also protected by the decoupling device from mechanical influences, and the effects thereof on a rechargeable battery connected to the rechargeable battery interface device are greatly reduced.

In an advantageous embodiment of a machine tool according to the invention, at least two rechargeable battery interface devices are provided, wherein a first rechargeable battery interface device is operatively connected to a first side handle, and a second rechargeable battery interface device is operatively connected to a second side handle, wherein a protective device is assigned to each battery interface device. Furthermore, it can also be provided that a common protective device is provided for at least two rechargeable battery interface devices.

A protective device can be arranged on the housing in a particularly simple manner by means of a screw connection. This makes it easy to replace a protective device. Alternatively or in addition to this, it can also be provided that at least one protective device can be arranged on the housing by means of at least one clamping connection, for example a tensioning strap or the like.

An arrangement of a protective apparatus is particularly simple, and freedom in the design of the protective apparatus is particularly great if at least one protective device is designed in at least two parts.

In an advantageous embodiment of a machine tool according to the invention, at least one interior of a protective device is designed such that, when the rechargeable battery is connected to a rechargeable battery interface device, a movement of at least one associated rechargeable battery in a direction of movement or about an axis of rotation is made possible to a defined extent. In this way, contact between the protective device arranged for relative movement and a rechargeable battery connected to a rechargeable battery interface device can be reliably prevented during the operation of the machine tool.

In an advantageous embodiment of a machine tool according to the invention, at least one protective device is designed such that, when the rechargeable battery is connected to the rechargeable battery interface device and the machine tool falls in any direction, the at least one protective device comes into contact with a flat base before the rechargeable battery connected to the rechargeable battery interface device. This can ensure particularly good protection of a rechargeable battery connected to a rechargeable battery interface device in any operating situation.

An improved embodiment of the invention with respect to a center of gravity, a view of a user in the direction of a working area, and a structural length of the machine tool is achieved if the rechargeable battery interface devices are arranged with respect to the longitudinal direction on a side of the respective side handle facing a tool holder and, in particular, are directly connected to the respective side handle.

To easily allow for an arrangement of a rechargeable battery in an insertion direction on the respective rechargeable battery interface device, at least one protective device can have a recess which points substantially in the transverse direction for the operative connection of a rechargeable battery to the rechargeable battery interface device. In principle, it can also be provided that the protective device is designed in such a way to allow an arrangement of a rechargeable battery on the respective rechargeable battery interface device in an insertion direction with any orientation.

An insertion device for the operative connection of a rechargeable battery to a rechargeable battery interface device can be at an angle with respect to a main extension direction of the respective side handle, wherein the angle is between- 30° and 90°, in particular between 0° and 30°, and preferably approximately 20°.

In an advantageous embodiment of a machine tool according to the invention, at least one rechargeable battery interface device has at least two connection regions for connecting the respective rechargeable battery interface device to the respective side handle, wherein two connection regions are spaced apart from one another in the transverse direction. In this way, a secure and stable connection of the rechargeable battery interface device to the respective side handle can be achieved.

In an advantageous development of the invention, the rechargeable battery interface device can be flexibly connected to the respective side handle in at least one connection region. This allows further damping of a rechargeable battery connected to the rechargeable battery interface device to be achieved. This can be particularly advantageous if the decoupling device of the respective side handle is in an extreme position in an operating state in which damping properties of the decoupling device are reduced, or the decoupling device has no damping properties. Furthermore, it can also be provided that the rechargeable battery interface device is articulated to the respective side handle in at least one connection region. It can also be provided that the rechargeable battery interface device is fixedly or rigidly connected to the respective side handle in both connection regions.

In an advantageous embodiment of the invention, to decouple the side handles from the housing, a first decoupling device is provided which has a first spring device and a first lever device by means of which the first side handle is rotatably articulated on a first pivot point fixed to the housing, and a second decoupling device is provided which has a second spring device and a second lever device, by means of which the second side handle is rotatably articulated on a second pivot point fixed to the housing, wherein the first spring device is mounted fixed to the housing on the one hand and is connected to the first lever device on the other hand, and wherein the second spring device is mounted fixed to the housing on the one hand and is connected to the second lever device on the other hand. The spring devices are designed in particular as tension springs and reduce vibrations acting on the side handles during operation of the machine tool.

Further advantages can be found in the following description of the figures. Different exemplary embodiments of the present invention are shown in the figures. The figures, the description, and the claims contain numerous features in combination. A person skilled in the art will expediently also consider the features individually and combine them to form useful additional combinations.

### BRIEF DESCRIPTION OF THE DRAWINGS

In the drawings:

FIG. 1 shows a side view of a machine tool designed as a jack hammer with a chisel arranged in a tool holder, wherein the machine tool is shown in an unloaded idle state;

FIG. 2 shows a three-dimensional view of the jack hammer according to FIG. 1;

FIG. 3 shows a side view corresponding to FIG. 1 of the jack hammer according to FIG. 1 and FIG. 2, wherein the jack hammer is shown without a housing part; and

FIG. 4 shows a side view of the jack hammer according to FIG. 1 to 3 arranged on a flat base.

### DETAILED DESCRIPTION

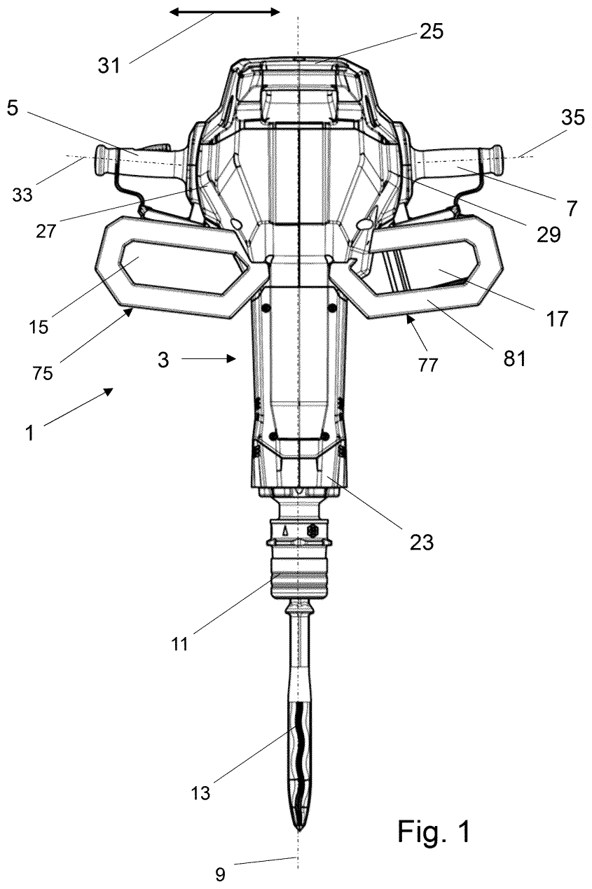

FIG. 1 to 4 each show a machine tool 1 in the form of a jack hammer. However, it is also possible for the machine tool 1 to be designed in the form of a screwdriver, a drill, a hammer drill or the like.

The machine tool 1 designed as a jack hammer is shown in the figures in an idle position, i.e. a non-actuated state, and has a housing 3 which can be designed in one part or in multiple parts. Furthermore, the machine tool 1 has a first side handle 5 and a second side handle 7 which are substantially symmetrical to a working axis 9 which defines a longitudinal axis or longitudinal direction of the machine tool 1. In the present case, a tool holder 11 is in engagement with a tool 13 designed as a chisel which is in the working axis 9.

The interior of the housing 3 substantially contains an electric motor and an impact apparatus. The impact apparatus can also be referred to as striking mechanism or striking apparatus. The electric motor and the impact apparatus are connected to one another in such a way that pulse-like impacts are generated and transmitted to the tool holder 11. Neither the electric motor nor the impact apparatus are shown in the figures.

In order to supply the machine tool 1 and in particular the electric motor with electrical energy, a first rechargeable battery 15 and a second rechargeable battery 17 are provided in the present case, wherein the first rechargeable battery 15 is operatively connected to a first rechargeable battery interface device 19, and the second rechargeable battery 17 is operatively connected to a second rechargeable battery interface device 21.

According to an alternative embodiment, it is also possible for only one rechargeable battery or more than two rechargeable batteries to be used.

The housing 3 has a lower end 23 in the longitudinal direction 9, in the region of which the tool holder 11 is provided, and an opposite upper end 25. Furthermore, the housing 3 has a first side region 27 and a second side region 29. The side regions 27, 29 form opposite boundaries of the housing 3 in the transverse direction 31. The transverse direction 31 is perpendicular to the working axis 9 and, in the present case, is substantially identical to main extension directions 33, 35 of the side handles 5, 7 when the machine tool 1 is in the idle state.

The first side handle 5 is arranged in the first side region 27, and the second side handle 7 is arranged in the second side region 29 of the housing 3.

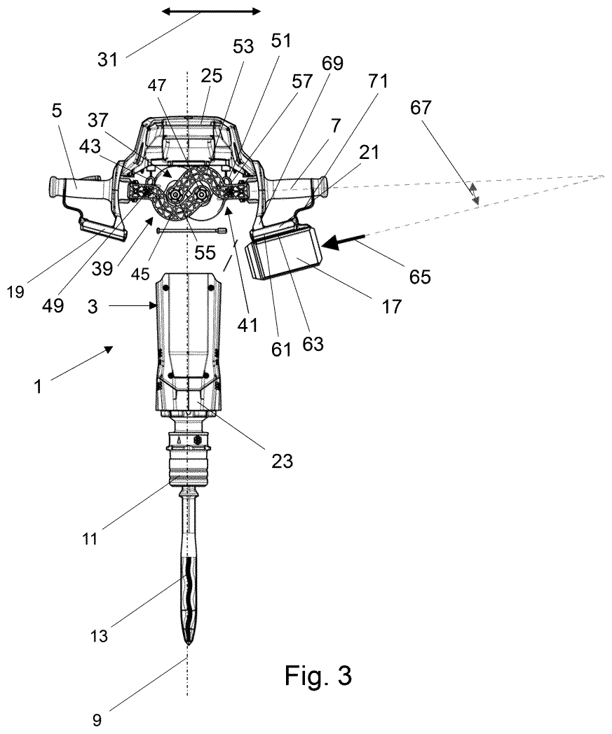

A decoupling apparatus 37, which can be seen in more detail in FIG. 3, is provided, by means of which the side handles 5 and 7 are decoupled to a certain extent from the housing 3 and accordingly from shocks, vibrations and the like that are transmitted to the housing 3 via the chisel 13 during operation of the machine tool 1.

In the present case, the decoupling apparatus 37 has a first decoupling device 39 assigned to the first side handle 5 and a second decoupling device 41 assigned to the second side handle 7. The first decoupling device 39 has a first spring device designed as a tension spring 43 and a first lever device 45, wherein the first lever device 45 is articulated on the one hand to a first pivot point 47 fixed to the housing, and on the other hand is connected to the first side handle 5. The first tension spring 43 is mounted fixed to the housing at the one end, and is connected at the other end to a first articulation point 49 which lies between the first pivot point 47 fixed to the housing and the first side handle 5. The first side handle 5 is accordingly displaceable in a circular sectional movement relative to the housing 3 about the first pivot point 47 fixed to the housing, so that the first main extension direction 33 is rotatable relative to the transverse direction 31 by a certain angular range.

Similar to this, the second decoupling device 41 has a second spring device designed as a tension spring 51 and a second lever device 53, wherein the second lever device 53 is articulated on the one hand to a second pivot point 55 fixed to the housing, and on the other hand is connected to the second side handle 7. The second tension spring 51 is mounted fixed to the housing at the one end, and is connected at the other end to a second articulation point 57 which lies between the first pivot point 47 fixed to the housing and the first side handle 5. The second side handle 7 is accordingly displaceable in a circular sectional movement relative to the housing 3 about the second pivot point 55 fixed to the housing, so that the second main extension direction 35 is rotatable relative to the transverse direction 31 by a certain angular range.

The first pivot point 47 fixed to the housing is arranged in the transverse direction 31 between the second pivot point 55 fixed to the housing and the second side handle 7. Consequently, the second pivot point 55 fixed to the housing is arranged in the transverse direction 31 between the first pivot point 47 fixed to the housing and the first side handle 5. In this case, the lever devices 45 and 53 are designed bent in opposite directions in such a way that they enable simultaneous downward and upward movement of the first side handle 5 and the second side handle 7 in the direction of the working axis by a rotational movement about the respective pivot point 47 or 55 fixed to the housing.

It can be provided that each decoupling device 39, 41 is assigned two tension springs 43, 51 so that two tension springs 43 interact with the first lever device 45 and two tension springs 51 interact with the second lever device 53.

The first rechargeable battery interface device 19 (see, e.g., FIG. 3) is arranged on the first side handle 5. Similar to this, the second rechargeable battery interface device 21 is arranged on the second side handle 7. The first rechargeable battery interface device 19 is substantially mirror-symmetrical to the second rechargeable battery interface device 21, wherein the connection of the second rechargeable battery interface device 21 to the second side handle 7 is described in the following as representative of the connection of the first rechargeable battery interface device 19 to the first side handle 5.

The second rechargeable battery interface device 21 has a substantially planar base plate 61 and a connection device 63 for receiving the second rechargeable battery 17, wherein the second rechargeable battery 17 is operatively connected to the connection device 63 via a movement in the insertion direction 65 and can be released from the connection device 63 in a direction of movement oriented in the opposite direction. With the aid of the connection device 63, the second rechargeable battery 17 can be detachably connected to the machine tool 1 both mechanically and electrically. The releasable connection of the second rechargeable battery 17 allows electrical energy to pass from the rechargeable batteries 15, 17 to the consumers, for example the electric motor, of the machine tool 1. It is possible for only a single rechargeable battery to be used to supply the machine tool 1.

The insertion direction 65 is at an angle 67 with respect to the second main extension direction 35 of the second side handle 7, wherein the angle 67 in the present case is approximately 20°.

In the present case, the second rechargeable battery interface device 21 has a first connection region 69 and a second connection region 71, wherein the second rechargeable battery interface device 21 is connected to the second side handle 7 via the two connection regions 69 and 71 without a connection fixed to the housing. The first connection region 69 and the second connection region 71 are arranged at a distance from one another in the transverse direction 31, wherein the first connection region 69 is arranged in a region facing the working axis 9, and the second connection region 71 is arranged in a region facing the second side handle 7. In the first connection region 69, the second rechargeable battery interface device 21 is connected substantially rigidly to the second side handle 7 in a region adjacent to the housing 3. In the present case, the second connection region 71 is flexible and allows a movement of the second rechargeable battery interface device 21 relative to the second side handle 7 which accordingly creates an additional decoupling of the second rechargeable battery interface device 21 relative to the housing 3.

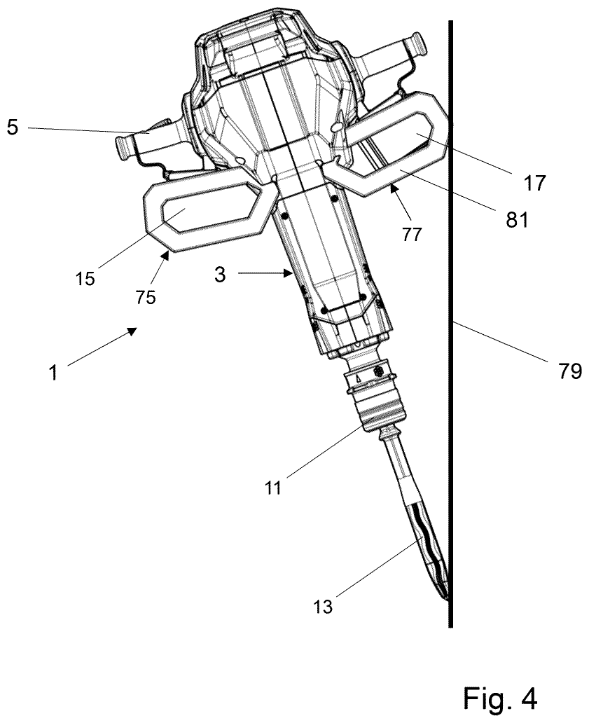

In this case, a protective device 75 or 77 is assigned to each rechargeable battery interface device 19, 21 and protects the rechargeable batteries 15 or 17 from a blow or impact in the event that the machine tool 1 drops or falls over, as shown in simplified form in FIG. 4. The protective devices 75, 77 are designed such that, for example, when the machine tool 1 falls over in any operating state the protective device 75 or 77 into contact with a surface 79 of a base (which is flat in this case), and protect the respective rechargeable battery 15, 17 from a blow or impact. Both the first protective device 75 and the second protective device 77 are arranged on the housing 3 so that the first rechargeable battery interface device 19 and the second rechargeable battery interface device 21 can be displaced relative to the first protective device 75 or the second protective device 77.

The first protection device 75 and the second protective device 77 are arranged and designed relative to each other in a substantially mirror-symmetrical manner with respect to the working axis 9. The second protective device 77 is described in more detail below as representative of the first protective device 75.

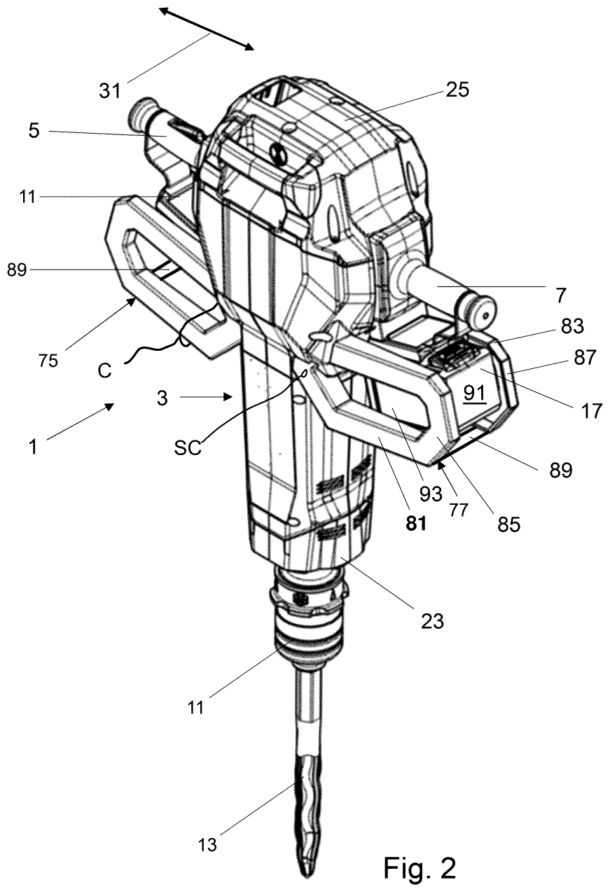

In the present case as shown, e.g., in FIG. 2, the second protective device 77 is designed in two parts with a first part 81 and a second part 83, wherein the first part 81 can be detachably brought into operative connection to the second part 83, in particular via a plurality of screw connections SC shown solely schematically as alternative in FIG. 2 or as discussed above as another alternative a clamping connection C for example a tensioning strap. Again via a plurality of screw connections, the parts 81, 83 that are connected to one another can be detachably arranged on the housing 3. Particularly good protection of the rechargeable batteries 15, 17 can be achieved by connecting the protective devices 77, 79 to the housing 3. According to an alternative embodiment, it can also be provided that the first part and/or the second part is fixedly, i.e. non-detachably, connected to the housing 3 of the machine tool 1 and, for example, is integral with the housing 3.

In the present case, the first part 81 and the second part 83 have a circumferential frame 85 or 87 or bracket, which are connected to one another via one or more connecting elements 89. Preferably, the connecting elements 89 are formed together by the first part 81 and the second part 83. Preferably, the connecting elements 89 are arranged on a side of the protective devices 77, 79 facing the tool holder 11.

The second protective device 77 has a recess 91 which enables an arrangement of the rechargeable battery 17 in the insertion direction 65 on the second rechargeable battery interface device 21. In alternative embodiments, the recess can also be provided at other positions so that an arrangement of the rechargeable battery on the second rechargeable battery interface device is possible with insertion directions 65 which are basically virtually arbitrary.

In a mounted state of the second protective device 77, i.e. when the two parts 81 and 83 are connected to one another and are connected to the housing 3 of the machine tool 1, the protective device 77 forms a type of cage with an interior 93. (See, e.g., FIG. 2). In the present case, the protective device 77 is designed such that the rechargeable battery 17 can in the present case be arranged completely in the interior 93 defined by the protective device 77.

The interior 93 of the protective device 77 is designed such that the rechargeable battery 17 can be displaced about the pivot point 55 fixed to the housing by a defined angular range, in particular occurring during operation of the machine tool 1, without coming into contact with the protective device 77.

In alternative embodiments, the protective device 77 can also be single-part or multi-part. In alternative embodiments, the parts 81, 83 can basically be designed as desired and do not have to form a circumferential frame. In addition, it can also be provided that, when the machine tool is in an unloaded state, the rechargeable battery is not arranged completely in the interior, but at least partially projects out of the interior. In this case, however, the protective device is preferably also designed in such a way that when the machine tool falls or drops in absolutely any direction, the protective device first comes into contact with a flat base.

What is claimed is:

1-13. (canceled)

14. A machine tool having a working axis running in a longitudinal direction, the machine tool comprising:
a housing;
at least one rechargeable battery interface for detachably connecting at least one rechargeable battery to the machine tool;
a first side handle having a first main extension direction and a second side handle having a second main extension direction, first and second the side handles being arranged symmetrically to the working axis;
at least one decoupler for a vibration-damping connection of the first and second side handles to the housing;
the at least one rechargeable battery interface being coupled to at least one of the first and second side handles; and
at least one protector for protecting a rechargeable battery coupled to the rechargeable battery interface, the at least one protector having an interior for at least partially receiving the at least one rechargeable battery, the at least one protector being directly connected to the housing or being an integral component of the housing.

15. The machine tool as recited in claim 14 wherein the at least one rechargeable battery interface includes a first rechargeable battery interface operatively connected to the first side handle and a second rechargeable battery interface operatively connected to the second side handle, the at least one protector including a first protector assigned to the first rechargeable battery interface and a second protector assigned to the second rechargeable battery interface.

16. The machine tool as recited in claim 14 wherein the protector is arranged on the housing via at least one screw connection.

17. The machine tool as recited in claim 14 wherein the protector is arranged on the housing via a clamp connection.

18. The machine tool as recited in claim 14 wherein the protector is designed in at least two parts.

19. The machine tool as recited in claim 14 wherein the interior is designed such that, when the rechargeable battery is connected to the rechargeable battery interface, a movement of the rechargeable battery in a direction of movement or about an axis of rotation is made possible to a defined extent.

20. The machine tool as recited in claim 14 wherein the protector is designed such that, when the rechargeable battery is connected to the rechargeable battery interface and the machine tool falls in any direction, the at least one protector comes into contact with a flat base before the rechargeable battery connected to the rechargeable battery interface.

21. The machine tool as recited in claim 14 wherein the rechargeable battery interface is arranged with respect to the longitudinal direction on a side of the first side handle facing a tool holder.

22. The machine tool as recited in claim 14 wherein the protector has a recess pointing substantially in the transverse direction for the operative connection of the rechargeable battery to the rechargeable battery interface.

23. The machine tool as recited in claim 14 wherein an insertion direction for connecting the rechargeable battery to the rechargeable battery interface device is at an angle with respect to a main extension direction of the first side handle, the angle being between −30° and 90°.

24. The machine tool as recited in claim 14 wherein an insertion direction for connecting the rechargeable battery to the rechargeable battery interface device is at an angle with respect to a main extension direction of the first side handle, the angle being between 0° and 30°.

25. The machine tool as recited in claim 14 wherein an insertion direction for connecting the rechargeable battery to the rechargeable battery interface device is at an angle with respect to a main extension direction of the first side handle, the angle being 20°.

26. The machine tool as recited in claim 14 wherein the at least one rechargeable battery interface has at least two connection regions for connecting the rechargeable battery interface to the first side handle, the two connection regions being spaced apart from one another in the transverse direction.

27. The machine tool as recited in claim 26 wherein the rechargeable battery interface is flexibly connected to the first side handle in at least one of the two connection regions.

28. The machine tool as recited in claim 14 wherein the at least one decoupler includes a first decoupler having a first spring and a first lever, the first side handle being rotatably articulated on a first pivot point fixed to the housing via the first lever, and a second decoupler having a second spring and a second lever, the second side handle being rotatably articulated on a second pivot point fixed to the housing via the second lever, wherein the first spring is mounted fixed to the housing on the one hand and connected to the first lever on the other hand, and wherein the second spring is mounted fixed to the housing on the one hand and is connected to the second lever device on the other hand.

29. The machine tool as recited in claim 14 wherein the machine tool is a jack hammer.
